(19) United States
(12) Patent Application Publication
(10) Pub. No.: US 2015/0248545 A1
(43) Pub. Date: Sep. 3, 2015

(54) SIGN SHORTCUT

(71) Applicant: Samer Al-Jamal, Raleigh, NC (US)

(72) Inventor: Samer Al-Jamal, Raleigh, NC (US)

(21) Appl. No.: 14/637,178

(22) Filed: Mar. 3, 2015

Related U.S. Application Data
(60) Provisional application No. 61/947,200, filed on Mar. 3, 2014.

(51) Int. Cl. G06F 21/31; G06F 3/0488; G06F 21/62; G06F 3/041

(52) U.S. Cl. CPC G06F 21/316; G06F 3/0412; G06F 3/04883; G06F 21/629; G06F 2203/04101; G06F 2203/04808

(57) ABSTRACT

An electronic device such as a smart phone or personal computer, adapted to both unlock and to execute at least one step of a standard operation such as placing a telephone call, responsive to the user executing only one input command The input command may comprise moving a slider on a touch screen, entering a predetermined combination of alphanumeric characters, and the like. The input command may also comprise hand drawing a symbol on the screen, whereupon the electronic device will execute a matching procedure similar to character recognition to authenticate the symbol. Authentication may then unlock the device and execute the at least one step of the standard operation.

### CROSS REFERENCE TO RELATED APPLICATION

This application claims the benefit of priority to U.S. Provisional Application Ser. No. 61/947,200, filed Mar. 3, 2014, the disclosure of which are hereby incorporated by reference.

### FIELD OF THE INVENTION

The present invention relates to electronic devices having display screens, and more particularly to an operating protocol which allows for symbols drawn on the screen which both unlocks the screen and makes progress towards device operation with as few as one manual user input command

### BACKGROUND OF THE INVENTION

Electronic devices having display screens, such as mobile telephones having touch screens, are typically provided with hard locks or virtual locks or both for restricting unauthorized or unintended use. A hard lock may be a switch for example. A virtual lock may demand a user action performed on the screen, such as dragging a virtual slider to a predetermined point on the screen, entering a code such as an alphanumeric code, or drawing a predetermined form or image on the screen. Appropriate user action unlocks the screen, or alternatively stated, enables ordinary function to proceed.

In most cases, a user picks up the device with a specific purpose in mind. With electronic devices such as mobile telephones, such a purpose is typically to place a telephone call, which may be in audible or text format. In conventional practice, the user first unlocks the device, then performs additional steps requiring the user to enter predetermined commands to invoke the desired function. Illustratively, the user may open a virtual telephone book or like directory by depressing one switch button, may search for a particular party or contact the user wishes to contact by operating a scrolling control, may activate appropriate contact information, such as entering a telephone number into an activation mode by depressing still another key button, thereby ultimately placing the desired telephone call.

Each of these three exemplary actions requires a specific manual input from the user. The sum total of these actions can become cumbersome and may be susceptible to introducing errors which force the user to start the procedure again. For example, should navigating through screen options require pressing relatively small real or hard keys or switch pushbuttons, or virtual keys of a touch screen keyboard, it is possible to active an unintended key, thus defeating progress made up to that point.

The field of electronic devices remains in need of a more expeditious way of facilitating completion of those standard operations that are possible for each type of electronic device.

### SUMMARY OF THE INVENTION

The present invention provides an expedited procedure for unlocking a locked screen and simultaneously progressing towards completion of a task, where a task will be understood to be a standard operation of that electronic device. This may be implemented by establishing a predetermined action, such as manipulating an icon such as a slider, entering one or more hand drawn symbols on a touch screen, by establishing a procedure utilizing standard controls such as pushbuttons, which may also be operated in an arbitrary, previously unused way, or by establishing any personalized input procedure that is other than a control procedure which is standard or recognized by the system prior to programming by the user.

In the present invention, performing the selected input procedure both unlocks the screen and also activates at least one subsequent step in implementing a standard operation of the device. For example, where the task is that of placing a telephone call, entry of a selected input may not only unlock a locked screen, but may also open a virtual telephone directory. Optionally, entry of the selected personalized input may perform a still further subsequent operation, such as moving a cursor to a predetermined location within the list presented as part of the virtual telephone directory. In an exemplary implementation, performing the unlocking action may not only unlock the screen, but may also display dialing options from the virtual telephone directory.

Hence what formerly required perhaps three or more discrete actions by the user in this example is now accomplished in one action. The user is more quickly advanced towards completion of the selected task. Simultaneously, opportunities for introducing errors, such as misdialing or touching an adjacent command area on the screen and thereby activating an unintended function, are defeated.

It is an object of the invention to expedite the process of performing a task on an electronic device having a locking screen.

Another object of the invention is to enable a user to selectable a procedure for unlocking the screen and commencing performing of a task.

It is an object of the invention to provide improved elements and arrangements thereof by apparatus for the purposes described which is inexpensive, dependable, and fully effective in accomplishing the intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a front view of a smart phone adapted according to at least one aspect of the invention.

FIG. 2 is a perspective view of a laptop computer adapted according to at least one aspect of the invention.

FIG. 3 is an exemplary image of an application of the smart phone of FIG. 1.

FIG. 4 is a depiction of an application of the smart phone of FIG. 1 when a prompt is made.

FIG. 5 is a depiction of the smart phone of FIG. 1 where the application is translating sign language.

FIG. 6 is shows exemplary content of the smart phone of FIG. 1 where a virtual assistant is being used.

FIG. 7 is a view of a screen displaying the use of concurrent signal and key to avoid confusion.

FIG. 8 is a view of a screen displaying the use of a slide bar and a slide object.

### DETAILED DESCRIPTION

The present invention sets forth an electronic device which processes data in the performance of a task. For the purposes of the present invention, a task is an operation in which data is processed to arrive at a desired goal, with the electronic device being a tool or implement to further implementation of the task. Examples of tasks include performing calculations, conducting or facilitating remote communications, retrieving and presenting information in user readable form, GPS navigation, and other operations which may be conducted by electronic telephones, personal digital assistants, computers, and like devices. A task may be thought of as an operation which the subject electronic device has been conceived. A task may be likened to a software application for example. In the example of data processing, the task could be regarded as generating a new document. Of course, it will be acknowledged that there are nonetheless variations in the scope of a task such as generating a new document, such as revising an existing document. However, for the purposes of this invention, a task is not intended to signify relatively minor operations such as utilizing a “delete” function to delete an unintended letter or word in the course of data processing. In a task, the user of the electronic device enters commands or enters, retrieves, or manipulates data or both to perform the task.

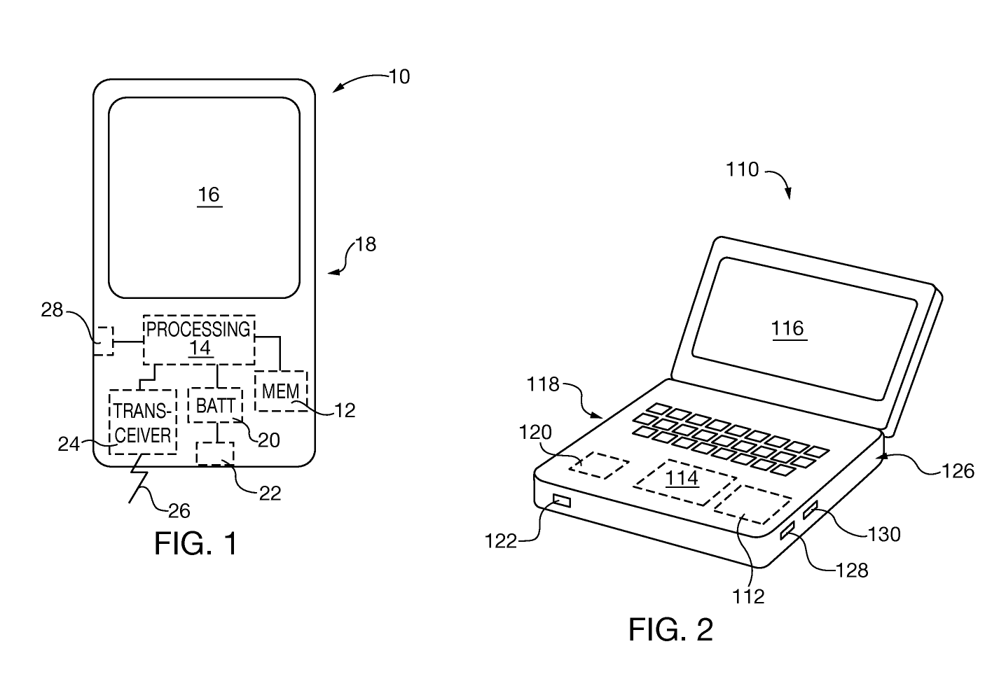

Referring now to FIG. 1, in one implementation of the invention, the electronic device may comprise a smart phone 10, which may comprise data handling apparatus including a memory device or a memory module 12, a data processor 14, a display screen or interface 16 disposed to present imagery thereon and which is controlled by the data handling apparatus, a network interface card, and a user interface such as real or virtual operating switches, all supported on or in a housing 18. The user interface is usable by a user to enter commands or data or both to the data handling apparatus.

The smart phone 10 may have a power source such as a battery 20, which may be rechargeable, a power port 22 for connection to a separate DC power supply (not shown), or both. The smart phone 10 may include a transceiver 24 for enabling wireless communication, represented as a radio signal 26, with communications networks (not shown). The transceiver 24 may of course comprise separate transmitter and receiver (not shown). The smart phone 10 may include a data port 28, for example of the type compatible with a USB (universal service bus) cable.

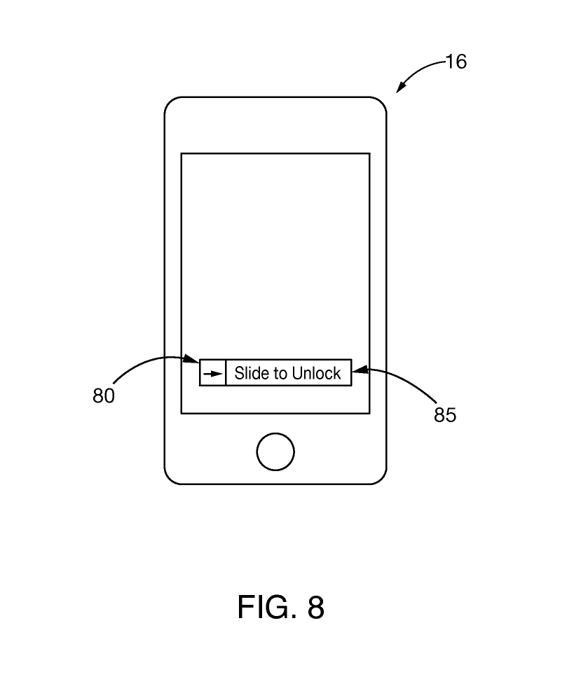

The screen 16 may be a touch screen or display, including virtual keys or operating pushbuttons that are adapted to accept commands and data inputs to the data handling apparatus. The screen 16 comprises a touch screen, it will be appreciated that the electronic device further comprises computer instructions loaded into the data handling apparatus, disposed to accept manual inputs established by making contact with the display screen 16. Hence where the display screen 16 comprises a touch screen, the touch screen both displays imagery generated by the electronic device and also serves as the user input interface. The computing system would include a processor configured to perform several steps. The first step would entail the processor to detect a finger, other body part or some sort of writing instrument capable of being detected by the touch screen. The next step would involve the finger or other instrument drawing a predefined symbol on the touch screen display. This may be a simple line or some complicated pattern on the touch screen display. This step would be followed by identifying a user interface object associated with the predefined symbol drawn by the finger or other writing instrument. The processor would recognize the predefined symbol and match that up with the user interface object. The last step would involve the processor performing an action prompted by the use of the user interface object associated with the predefined symbol drawn by the finger contact on the touch screen. The processor would recognize the symbol, match that up with a user interface object and then perform the action. This may be as simple as the user interface object being a slide bar 80 and slide object 85, as seen in FIG. 8.

Another embodiment of the system includes identifying the slide bar 80 at a first position of the touch screen. The process would then detect the finger contact at a second position on the touch screen. As such the processor would then set a distance between the first position and the second position. When the user moves the slide object 85 along the slide bar 80, the processor may determine the finger has traveled the predefined distance between the first position and second position thereby activating the predefined action. In simpler terms, the user would slide the slide bar. Once the processor has determined that the predefined distance has been activated, the predefined action would be initiated which would prompt the processor to perform the task of the predefined action. Non-limiting examples of this would be to unlock a computing device, start a computer device function or some other predefined action.

As a non-limiting example, the touch screen may be able to accept manual inputs by the use of a finger, another body part or some writing or other instrument.

The electronic device may be other than the smart phone 10. The electronic device may take the form of any hand held or portable or mobile communications device such as a personal digital assistant, or a device primarily intended as a data processor, including portable computing devices such as tablets, notebooks, laptop computers, and even stationary computers such as desktops.

FIG. 2 illustrates an example of a data processing form of electronic device which is capable of processing data and performing at least one task. The electronic device may take the form of a laptop computer 110 comprising data handling apparatus including memory 112 and a data processor 114, a display screen 116 which is the functional equivalent of the display screen 16, and a user input interface 126 usable by a user to enter at least one of commands and data to the data handling apparatus.

As illustrated in the example of FIG. 2, the user input interface 126 may comprise a plurality of switches which are depicted as pushbuttons, which would be that portion of each switch visible to the user outside the housing 118 of the laptop computer 110. Of course, the user interface 126 may comprise controls other than or in addition to pushbutton operated switches, such as rotary dial controls, rocker switches, slidable operator switches, toggle operated switches, and others, in any combination. Even beyond these examples, the user input interface 126 may comprise any device or apparatus which is disposed to accept inputs from a person using the laptop computer 110, and to communicate the inputs to the data handling apparatus for use with or by any of the various computer instructions which may be loaded into the data handling apparatus.

The laptop computer 110 may have a suitable power supply 120 which may comprise an AC to DC converter with or without a power cord, and with or without a battery connected thereto. As an alternative to a power cord, the laptop computer may have a power port 122 arranged for either AC or DC supply. The laptop computer may comprise data transfer apparatus such as a data port 128 which may for example be compatible with a USB cable or a data port 130 or both. Although connections among the functional components of the laptop computer 110 are not shown as are corresponding connections in FIG. 1, it will be understood that these functional components are provided with electrical conductors, switches, and other apparatus necessary for operation as described herein.

It should be mentioned at this point that the transceiver 24 of the smart phone 10 and the 128 and 130 may be regarded as communications elements which may take the form of any one or more devices which are collectively capable of transmitting data remotely using a communications network, receiving data from a communications network, or both transmitting and receiving data remotely using a communications network. The communications capability may be for example among those which are commercially available to be communicably compatible with the internet or cellular telephone systems or both. In such cases, and as would apply to telephonic devices such as the smart phone 10 and to network compatible computers such as the laptop computer 110, it will be appreciated that the task may be communications related, for example, comprising processing data for subsequent transmission, processing data received from the communications network, or both.

FIGS. 1 and 2 illustrate two of many possible physical forms of electronic devices which may be utilized with the present invention. Regardless of the physical form of the electronic device, it will be provided with computer instructions loaded into the data handling apparatus, disposed to implement the task. Again, the task may be any ordinary function provided by the electronic device, in the course of implementation of which, data is processed. The electronic device is provided with computer instructions loaded into the data handling apparatus disposed to lock the screen such as the screens 16 or 116 responsive to a predetermined condition; and is provided with computer instructions loaded into the data handling apparatus, disposed both to unlock the screen and also to at least initiate implementation of the task responsive to entry of an input action by the user to the user input interface, such as the user interface 126, or the screen 16, where the latter is a touch screen displaying virtual controls. Examples of predetermined conditions which may lock the screen such as the screen 16 or 116 include inactivity for a predetermined time interval, and intentional locking by entry of a predetermined command for security purposes. As a non-limiting example, the predefined action may include where the slide bar is activated whereby unlocking the computing device.

The task may be partially or fully implemented as part of the action which unlocks the screen such as the screen 16 or 116. For the purposes of this invention, at least initiating implementation of the task will be understood to signify that an input action, such as depressing one real or virtual key or pushbutton, causes the processor such as the processors 14 and 114 to advance towards at least partial completion of the task. At least initiating implementation may extend even to fully completing the task. In an illustrative example which could be associated with the smart phone 10, the task may be that of placing a voice protocol telephone call to a particular party whose telephone number has previously been loaded into the smart phone 10. In conventional schemes, and as referred to priory, an exemplary path to completion of a corresponding task may require first unlocking the screen, then entering commands at various points along the path which culminates with the subject conventional telephone placing the call. One illustrative point along this path may include a step of opening a directory showing names or telephone numbers or both which are available from the memory of the conventional telephone. A prompt may be displayed, which prompt may require depression of a key or pushbutton to execute the step of displaying names or numbers. A second prompt may require depression of a key or pushbutton on a selected name or number. This second action may only designate the selection, and may possibly not execute the selected call, thereby requiring a third action, namely that of effecting the call.

As a non-limiting example, to prevent an accidental activating of actions, the system may require the drawing a predefined symbol on the touch screen display with the finger or other writing instrument and then pressing a function key such as a button on the side of the computing device simultaneously.

In the present invention, and using the same sequence of steps as an illustration, proceeding past screen unlock to the first or second step along the path would constitute partial implementation of the task of placing the selected call. It would also be possible to proceed past screen unlock to the third step of effecting the call, thereby fully implementing the task.

This procedure may entail more than advancing directly from screen unlock to a necessary step along the path to completion, where the degree of implementation is limited to combining many conventionally necessary steps into one. Such a procedure would merely introduce an economy into the process. However, the procedure may advance past a choice, at which point conventional practice requires affirmative user input, without which user input progress would stop. An example of such a choice is selection of which party to call. A second example of choice is a decision whether to effect a conventional voice call, whether to transmit a pre-recorded message, or whether to select texting format. Some parties whose telephone numbers have been entered into memory may require a message affirming, negating, or modifying a standing instruction. For example, in a business environment, one may call a pre-established commercial source of business supplies, leaving a pre-recorded message to the effect that a typical monthly order for a particular supply, such as goods or services, is to be fulfilled without modification the following month. Alternatively, quantities or selections may be modified by predetermined arrangement. In this example, not only would the user of the smart phone 10 identify the party being called, but would also designate one of at least one prerecorded message to transmit. For other parties, a live call may be preferred. In the first example, using a conventional telephone scheme, a first choice that of designating the party being called is made. Next, a second choice is made, that of designating which prerecorded message is to be transmitted. In the case of the live call, only designation of the party is necessary.

Therefore, the act of unlocking the screen 16 of the smart phone 10 could advance different degrees along the path to full implementation of the task, depending on which choices are to be made and which choices may be bypassed.

To summarize, the novel procedure not only introduces economizing steps, but may also advance past choices which otherwise would require affirmative selection by the user.

A corresponding operation may be conducted using an electronic device such as the laptop computer 110. Using the example of sending an email to a designated party, at least partial implementation of the task could signify that an email recipient is selected, with an empty window being displayed on the screen to enable a personalized message to be entered thereon. A full implementation could be selection and transmission of a predetermined message, such as that affirming that a standing order for supplies will indeed apply for the next month. The otherwise necessary step of choosing a party to contact, and in the example of selection of predetermined message, the otherwise necessary step of filling in the intended message, may both be bypassed.

In a further aspect of the invention, at least initiating implementation of the task may be responsive to entry of one and only one input action by the user. It should be understood that the one input action may literally require more than one haptic or physiological motion by the user. For example, in situations requiring entry of a multi-digit number such as a telephone number, Social Security number, or the like, several discrete depressions of a key or switch operator by finger may be required. However, the system which requires entry of the multi-digit number will not continue the process until the entire number has been entered. Some systems are sensitive to the number of digits entered, and will take further appropriate action responsive to entry of the requisite number of digits. Other systems require a separate command to act on entry of the entered digits. Regardless of the number of finger depressions or other physiological motions by the user or of the number of switch actions necessary, the one and only one action will be understood to include sufficient actions for the system of the electronic device to recognize and be able to proceed on the basis of the entered command This arrangement is different from an arrangement wherein a first user input action is not followed by a response by the electronic device requiring a subsequent user input action to enable the electronic device to recognize the input as a valid command, and to proceed responsively thereto.

The computer instructions which are loaded into the data handling apparatus and are disposed both to unlock the screen and also to at least initiate implementation of the task may comprises at least one user selectable command which may be entered using the user interface device. That is, rather than have the electronic device react to only one predetermined command mandated by the manufacturer of the electronic device, the electronic device may offer a plurality of commands.

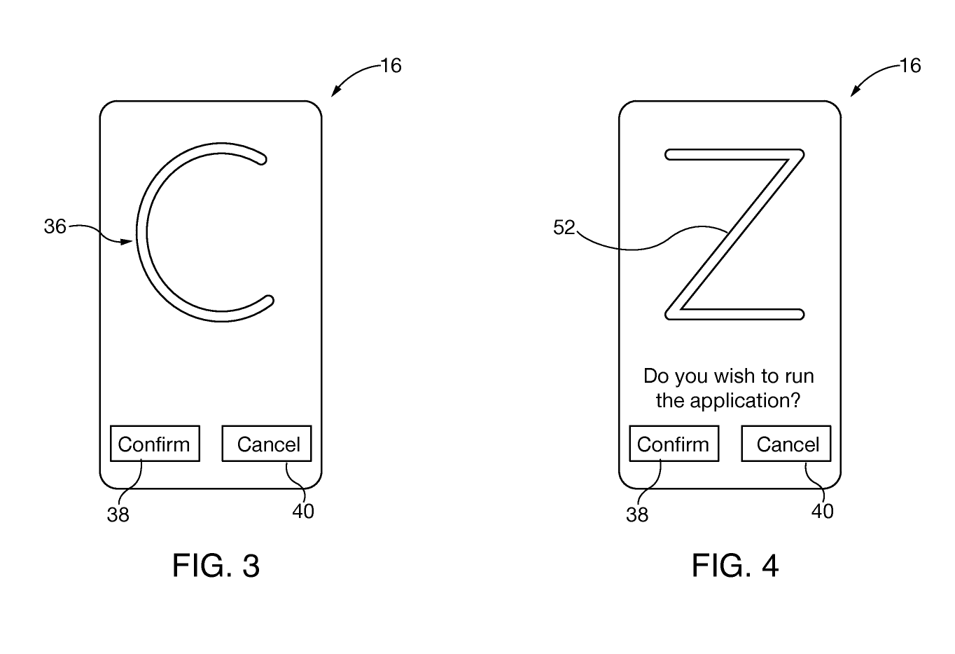

In FIG. 3, illustrates an example of an embodiment of the invention, the user will be able to prompt your iPhone or any other personal communication device 10 to execute commands by drawing with your finger on the touch screen 16 a pre-assigned sign. Some of the sign shortcuts will be universal for certain commands (swipe diagonally to show home screen, zigzag “3” to swap between last app and current app, “C” 36 to launch phone call, “e” to launch Mail, etc.

As a non-limiting example, the screen is seen to display two virtual sliders appearing thereon. The sliders may bear respective associated legends which identify the function of each slider. The upper slider identifies a first party who may be contacted using the smart phone, and the second slider launches navigation software provided by smart phone, which will provide directions to the address listed for a second party. Using either slider may not only unlock the screen, but may also place a call to the party identified as John, or may enable GPS navigation to provide directions to the address of the party identified as Mary.

FIG. 3 illustrates a feature wherein the computer instructions loaded into the data handling apparatus, disposed both to unlock the screen and also to at least initiate implementation of the task are functional to respond to a plurality of user selectable commands which may be entered using the user interface device, and wherein each one of the user selectable commands both unlocks the screen and also at least initiates implementation of a different task independently of the existence of another user selectable command

As a non-limiting example, it is possible not only to provide plural selectable user input commands which have been pre-established by the manufacturer and which may be presented for example as a menu, but also to enable the user to create his or her own user selectable commands. A personalized character in the form of a hand drawn image or character, such character, has been drawn on the screen. This character may be entered into memory and designated as an authenticating icon which will be processed in subsequent entries and verified by a suitable image recognition program which may be part of the computer instructions loaded into the smart phone. The image recognition program is functional to recognize hand drawn characters to determine authentication of an authorized user, unlock the device, enable initiation of the task to proceed when authentication is determined, and to block initiation of the task when authentication is not determined. The image recognition program may store plural renderings of each entered image to assist in determining a match between an image being entered for authentication, and data available to the image recognition program for assessing that image being entered. Thus the system may have a library of images which may be used in “look-up” fashion for example.

Images may be uncomplicated geometric forms, for example including ovals, squares, triangles, and others. In one implementation of the invention, each image may be recorded in the library from ten samples.

After the character is entered onto the screen, a prompt such as the box displaying the legend “confirm” may be activated to compete loading of the character into memory for subsequent use in authentication. It should be noted that the box may be utilized not only in initial programming of accepted symbols for entry into memory, but may also be used to add to the library of symbols which have previously been designated as acceptable.

Alternatively, should the user decide not to use the character as drawn, he or she may elect to activate a prompt which terminates the process of registering or recording the character. This may be done to accommodate a user's judgment that the symbol was not properly drawn, or is better used in another way.

As a non-limiting example, the user will draw on the screen a sign—say “C”—and the Smart Phone will open up the iPhone App or draw “e” and the phone will open up the Mail App. In addition, the user will draw diagonal line “/” to go home scream or zigzag to swap between Apps.

FIG. 4 illustrates an embodiment of the invention which by swiping the smart phone touch screen 10 (or drawing with your finger) a certain symbol “Z” 52; it will prompt the phone 16 to launch an application, where the home screen, swap between two applications and other predetermined commands. Also, it will be able to assign sign shortcut for each application on the phone and it will be able to launch that application by drawing the sign on the screen with your finger.

As a non-limiting example, programming the smart phone to associate a given designated authenticating icon with one particular option. The various parties, telephone numbers, addresses, and other related information loaded into the data handling apparatus of the smart phone may be displayed. A different icon may be established as being registered for any relevant information.

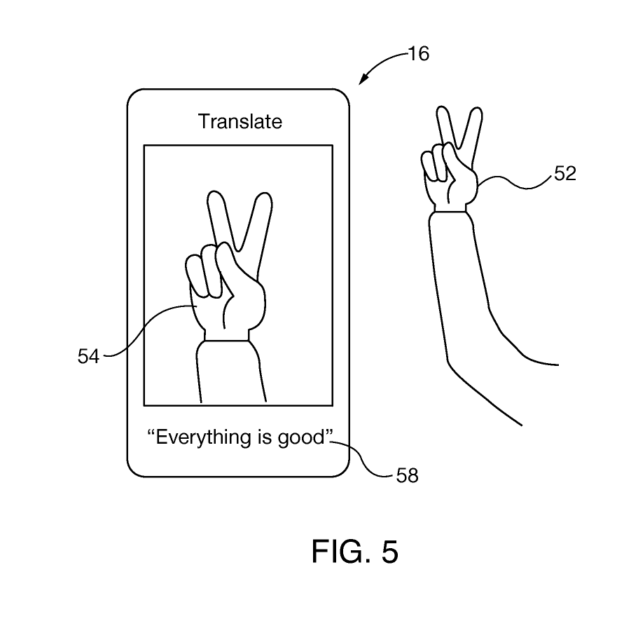

As seen in FIG. 5, another embodiment of the invention is that the Sign Shortcut Application could also be used to translate signs to words and will help Deaf-Mute users to use the iPhone or any other personal communication device 16 as a translation device (translate sign language to spoken words) 58. The phone 16 could take a video or picture of the sign language 52, then the application would translate the sign 58 based on a data base of signs.

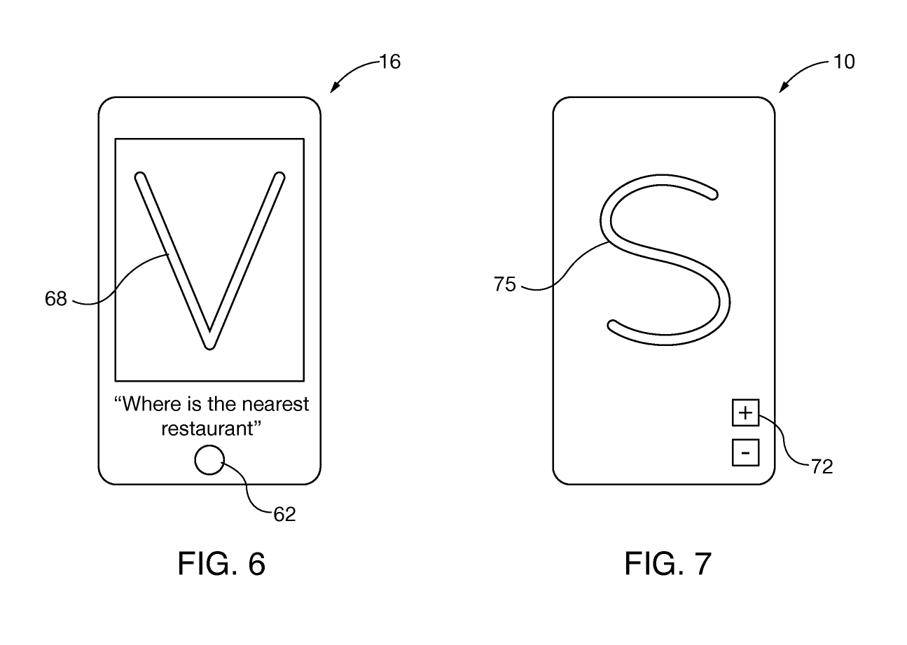

As illustrated in FIG. 6, another embodiment of the invention will allow users to communicate with their iPhone or any other personal communication device 10 without using words. It will eventually enable users to all the functions that “Siri” or a virtual assistant does without speaking. The user may press the activation system 62 or start the virtual assistant. Once a finger gesture or command “V” 68 is entered on the screen 10, then the virtual assistant will obey any command the user wishes. As a non-limiting example, the virtual assistant could translate a sign, or find a restaurant or any other service.

As seen in FIG. 7, an embodiment of the invention can start as an application that works in the background and will allow the user to launch commands by drawing “signing” a certain symbol 75 on the screen while using a concurrent signal and key to avoid confusion. To make the iphone or any other personal communication device 10 recognize that this swiping motion is meant as a shortcut and not confuse as scrolling, a combination of other functions like pressing the “+” button 72 while drawing the sign 75. It may be possible for phones 10 to have a sensor on the side that will cover-up with a hand grip while drawing the shortcut sign to prompt the function recognition.

As a non-limiting example, an alternative to the use of sliders, it would be possible either in a touch screen device, such as the smart phone 10, or alternatively, with a device having actual keys, such as the user input interface of the laptop computer, or virtual keys, to use entry of alphanumeric characters as a personal identification code. In this option, a user can register designated identification codes corresponding to any relevant information related to a user's contacts. Similar to using registered gestures as shortcuts, a user can user registered identification codes as shortcuts to performed designated tasks as well. It should be mentioned that similar functions may be implemented in a device having hard switches or keys, such as the laptop computer.

Whether hard switches or keys or virtual switches or keys are used, these switches may correspond to alphanumeric symbols. Alphanumeric symbols will be understood to encompass any or all know symbols, such as scientific symbols, astrological symbols, typographic symbols, alphabetical characters of non-Roman alphabets, and others. It will also be appreciated that service keys or switches such as power controlling switches, sound volume controls, camera operator buttons, and the like, may be incorporated into the pool of user operators which may be employed to establish a programmed command At least one of the user selectable commands may comprise a personalized sequence of alphanumeric symbols. That is, the selected command may utilize a user selected pattern of symbols. It would also be possible that the selected command comprise simultaneous operation of at least two different switches. If desired, the system may consider the time interval of depression of a key or other switch or command action.

As another non-limiting example, entry of a screen unlocking operator, may cause the electronic device to display prompts. This may arise for example should the screen unlocking operator not be previously programmed to select a specific action which is available. The choice may now be made using the appropriate prompt.

Another non-limiting example shows how an electronic device such as the smart phone may accommodate failure to identify an entered image. Should the image recognition program which has been loaded into the electronic device fail to match the entered character with any one image loaded into memory during programming of the electronic device, the system may respond by offering choices. These choices would specify the option to call respectively a first party or a second party, whose contact data has been loaded into the data handling apparatus of the electronic device. If either of these choices is not satisfactory, the user may select a prompt, which returns the process to the point at which the user enters the hand drawn image, such as the character. Should the redrawn character better match the archived examples of characters, implementation of the task may proceed.

As another non-limiting example, the system for drawing symbols on a computing device may be perform an action prompted by the use of the user interface object associated with the predefined symbol drawn by the finger contact on the touch screen to launch a computing device related program. That may include functions such as making phone calls or bringing up a computer related program on the computing device.

Moreover, the different embodiments discussed previously, including but not limited to, the system for drawing symbols on a computing device may be directed to a method of drawing symbols on a computing device to invoke desired functions.

Although explanation of the invention is set forth largely in terms of the smart phone, which is representative of mobile, hand held, communications capable devices, it will be apparent to those of skill in the art will recognize that the principles of the invention may be applied to all manner of hand held devices such as iPads and other tablets.

Reference to the various computer instructions loaded into the data handling apparatus need not imply permanent or exclusive residence of such computer instructions within the subject electronic device. Of course, the computer instructions could if desired reside permanently or exclusively in whole or in part within the electronic device as software or firmware for example. However, it would also be possible for the computer instructions to be provided or to operate remotely, such as from a remote computer or server (not shown) in whole or in part in at least partially implementing the selected task.

The particular features, structures, or characteristics described herein may be combined in any suitable manner in one or more implementations of the invention. Notably, although the example of the smart phone is primarily intended to illustrate features of a device having a touch screen, and the example of the laptop computer is intended to illustrate features of a device having physical switch controls, it would be possible for these features to appear in either type of device, and for both sets of features to appear in any one of these exemplary types of devices.

It will be understood by those skilled in the art that each function or operation or both as described herein can be implemented, individually and collectively or both, by a wide range of hardware, software, firmware, or virtually any combination thereof.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A system for drawing symbols on a computing device which includes a memory module, a display interface, a network interface card, a transceiver, a battery, and a touch screen display to invoke desired functions, the system comprising:
a computing system including a processor configured to perform the following:
detecting a finger contact with the touch screen display on the computing device;
drawing a predefined symbol on the touch screen display with the finger;
identifying a user interface object associated with the predefined symbol drawn by the finger contact on the touch screen; and
performing an action prompted by the use of the user interface object associated with the predefined symbol drawn by the finger contact on the touch screen.

2. The system of claim 1, wherein the user interface object is a slide bar and slide object.

3. The system of claim 2, further comprising:
identifying the slide bar at a first position of the touch screen;
detecting the finger contact at a second position on the touch screen;
setting a distance between the first position and the second position;
moving the slide object along the slide bar within a predefined distance between the first position and second position;
determining the finger has traveled the predefined distance between the first position and second position thereby activating the predefined action; and
performing the task of a predefined action.

4. The system of claim 3, wherein the predefined action is unlocking the computing device.

5. The system of claim 1, wherein the drawing a predefined symbol on the touch screen display with the finger and pressing a function key simultaneously will perform the action.

6. The system of claim 1, wherein the drawing a predefined symbol on the touch screen display with the finger is a V shape.

7. The system of claim 1, wherein the drawing a predefined symbol on the touch screen display with the finger is a Z shape.

8. The system of claim 1, wherein the drawing a predefined symbol on the touch screen display with the finger is a C shape.

9. The system of claim 1, wherein the drawing a predefined symbol on the touch screen display with the finger is an S shape.

10. The system of claim 1, wherein performing an action prompted by the use of the user interface object associated with the predefined symbol drawn by the finger contact on the touch screen is to launch a computing device related program.

11. A computing device implemented method of drawing symbols on a computing device which includes a memory module, a display interface, a network interface card, a transceiver, a battery, and a touch screen display to invoke desired functions, comprising:
detecting a finger contact with the touch screen display on the computing device;
drawing a predefined symbol on the touch screen display with the finger;
identifying a user interface object associated with the predefined symbol drawn by the finger contact on the touch screen; and
performing an action prompted by the use of the user interface object associated with the predefined symbol drawn by the finger contact on the touch screen.

12. The method of claim 11, wherein the user interface object is a slide bar and slide object.

13. The method of claim 12, further comprising:
identifying the slide bar at a first position of the touch screen;
detecting the finger contact at a second position on the touch screen;
setting a distance between the first position and the second position;
moving the slide object and along the slide bar within a predefined distance between the first position and second position;
determining the finger has traveled the predefined distance between the first position and second position thereby activating the predefined action; and
performing the task of a predefined action.

14. The method of claim 13, wherein the predefined action is unlocking the computing device.

15. The method of claim 11, wherein the drawing a predefined symbol on the touch screen display with the finger and pressing a function key simultaneously will perform the action.

16. The method of claim 11, wherein the drawing a predefined symbol on the touch screen display with the finger is a V shape.

17. The method of claim 11, wherein the drawing a predefined symbol on the touch screen display with the finger is a Z shape.

18. The method of claim 11, wherein the drawing a predefined symbol on the touch screen display with the finger is a C shape.

19. The method of claim 11, wherein the drawing a predefined symbol on the touch screen display with the finger is an S shape.

20. The method of claim 11, wherein performing an action prompted by the use of the user interface object associated with the predefined symbol drawn by the finger contact on the touch screen is to launch a computing device related program.
